(19) United States
(12) Patent Application Publication
(10) Pub. No.: US 2024/0228739 A1
(43) Pub. Date: Jul. 11, 2024

(54) COMPOSITION, METHOD FOR PRODUCING CURED PRODUCT, AND CURED PRODUCT

(71) Applicant: ADEKA CORPORATION, Tokyo (JP)

(72) Inventors: Takashige IKEDA, Tokyo (JP); Yusuke NUIDA, Tokyo (JP)

(21) Appl. No.: 18/556,274

(22) PCT Filed: May 10, 2022
(86) PCT No.: PCT/JP2022/019828

§ 371 Date: Oct. 19, 2023

(30) Foreign Application Priority Data
May 28, 2021 (JP) 2021-090079

(51) Int. Cl. C08K 3/08; C08J 7/04; C08K 5/00; C08K 9/04; C08L 63/00

(52) U.S. Cl. CPC C08K 3/08; C08J 7/04; C08K 5/0025; C08K 9/04; C08L 63/00; C08J 2363/00; C08K 2003/0806; C08K 2003/085

(57) ABSTRACT

There is provided a composition that makes it possible to produce a cured product having a low volume resistance value, a cured product obtained by curing the composition, and a method for producing a cured product using the composition. The composition contains a component (A): at least metal particles selected from the group consisting of copper particles and silver particles, a component (B): at least one cashew component selected from the group consisting of cashew oils and cashew oil-modified resins, and a component (C): a curing agent. The cured product is obtained by curing the composition. The method for producing a cured product includes a coating step of coating a substrate with the composition and a curing step of heating the substrate coated with the composition to cure the composition.

### TECHNICAL FIELD

The present invention relates to a composition, a method for producing a cured product, and a cured product.

### BACKGROUND ART

Compositions containing an electrically conductive metal are used as one of materials for producing circuit wiring, touch panels, solar cells, sensors, and the like. Currently, copper particles and silver particles are particularly attracting attention as electrically conductive metals and various compositions containing copper particles or silver particles are being studied.

For example, Patent Literature 1 discloses a copper paste composition containing copper particles, a resol type phenolic resin, and a vinylphenol-based polymer. Patent Literature 2 discloses an electrically conductive copper paste containing copper particles, a resol type phenolic resin, an epoxy resin, and an organic acid. Patent Literature 3 discloses an electrically conductive paste containing a silver-coated copper powder and an epoxy resin. Patent Literature 4 discloses an electrically conductive silver paste containing a spherical silver powder and a thermosetting epoxy resin. Patent Literature 5 discloses an electrically conductive paste containing a silver-coated copper powder and a bisphenol F type epoxy resin.

### CITATION LIST

### Patent Literature

Patent Literature 1: Japanese Patent Laid-Open No. 2018-092864
Patent Literature 2: Japanese Patent Laid-Open No. 2018-181558
Patent Literature 3: Japanese Patent Laid-Open No. 2012-167337
Patent Literature 4: Japanese Patent Laid-Open No. 2012-248370
Patent Literature 5: Japanese Patent Laid-Open No. 2020-033610

### SUMMARY OF INVENTION

### Technical Problem

However, a cured product obtained by curing any of the compositions as disclosed in Patent Literatures 1 to 5 is not satisfactory in terms of volume resistance value that is required for materials in the electronic material field in recent years.

Thus, the present invention intends to provide a composition that makes it possible to produce a cured product having a low volume resistance value. Further, the present invention intends to provide a method for producing a cured product using the composition and a cured product obtained by curing the composition.

### Solution to Problem

The present inventors have conducted diligent studies in order to obtain the above-described composition to find that use of a composition containing particular components makes it possible to produce a cured product having a low volume resistance value, and completed the present invention.

That is, the present invention provides a composition comprising a component (A): at least metal particles selected from the group consisting of copper particles and silver particles, a component (B): at least one cashew component selected from the group consisting of cashew oils and cashew oil-modified resins, and a component (C): a curing agent.

The present invention further provides a method for producing a cured product, the method comprising: a coating step of coating a substrate with the above-described composition; and a curing step of heating the substrate coated with the composition to cure the composition.

The present invention further provides a cured product obtained by curing the above-described composition.

### Advantageous Effects of Invention

The present invention can provide a composition that makes it possible to produce a cured product having a low volume resistance value. Further, the present invention can provide a method for producing a cured product using the composition, and a cured product obtained by curing the composition.

### DESCRIPTION OF EMBODIMENTS

Hereinafter, embodiments of the present invention will be described in detail. A composition of one embodiment of the present invention (hereinafter, also simply referred to as “composition”) is a composition containing, as essential components, a component (A): at least metal particles selected from the group consisting of copper particles and silver particles (hereinafter, also simply referred to as “component (A)”), a component (B): at least one cashew component selected from the group consisting of cashew oils and cashew oil-modified resins (hereinafter, also simply referred to as “component (B)”), and a component (C): a curing agent (hereinafter, also simply referred to as “component (C)”).

The component (A) contains at least metal particles selected from the group consisting of copper particles and silver particles. The types of the copper particles and the silver particles are not particularly limited, and generally known copper particles and silver particles can be used. Among these, the component (A) preferably consists of copper particles because of easiness of processing, availability, and being inexpensive.

In addition, the average particle size of the component (A) is preferably 0.1 to 20 μm, more preferably 0.5 to 10 μm, still more preferably 1.0 to 5.0 μm, because a cured product having a lower volume resistance value can be produced. The average particle size of the component (A) represents a particle size (D₅₀) at which the cumulative volume reaches 50% in the particle size distribution based on volume, the particle size (D₅₀) measured and calculated using a laser light diffraction particle size distribution analyzer. Note that when the metal particles are surface-treated a fatty acid or the like, which will be mentioned later, the average particle size of the component (A) can be obtained by measuring the particle size of the metal particles after the surface treatment.

The shape of the component (A) is not particularly limited, and one, or two or more of granular, needle, flake, and other particles can be used. Among others, the composition preferably contains granular component (A) because a cured product having a lower volume resistance value can be produced. Note that herein, both of scale-like metal particles and plate-like metal particles are included in the flake metal particles.

In the case where the metal particles have been oxidized by air or the like, a cured product having a lower volume resistance value can be produced, and therefore the metal particles are preferably washed in advance using an aqueous solution in which an inorganic acid or an organic acid is dissolved. For example, an aqueous solution in which sulfuric acid is dissolved is preferably used as the aqueous solution which is used for washing.

In addition, the metal particles (copper particles and silver particles) may be surface-treated metal particles or untreated metal particles, but the metal particles (copper particles and silver particles) are extremely easily oxidized by air, and therefore the metal particles are preferably surface-treated with a fatty acid and the component (A) preferably consists of metal particles surface-treated with a fatty acid. Among the components (A) such that the metal particles are surface-treated with a fatty acid, the component (A) more preferably consists of metal particles surface-treated with stearic acid.

The content of the component (A) in the composition is preferably 50 to 99 parts by mass based on 100 parts by mass of the total amount of the composition (in other words, 50 to 99% by mass based on the total mass of the composition). When the content of the component (A) is in the above-described range, thereby a cured product having excellent thermal stability and adhesiveness and having a lower volume resistance value can be produced. From this viewpoint, the content of the composition (A) in the composition is more preferably 60 to 97 parts by mass, still more preferably 70 to 95 parts by mass, based on 100 parts by mass of the total amount of the composition.

The component (B) is at least one cashew component selected from the group consisting of cashew oils and cashew oil-modified resins. The component (B) can be a commercially available product.

Examples of commercially available cashew oils include, by product names, CX-1000 and No. 930 (all manufactured by Cashew Co., Ltd.); CNSL, LB-7000, LB-7250, CD-5L, LB-3025, and LB-3111 (all manufactured by Tohoku Chemical Industries, Ltd.); and NX-2021, NX-2022, NX-2023, NX-2023D, NX-2024, NX-2025, NX-2026, NX-5285, NX-9001, NX-9001LV, NX-9004, NX-9005, NX-9006, NX-9007, NX-9008, NX-9201, NX-9201LP, NX-9203, NX-9203LP, GX-2503, GX-9002, NC-510, LITE2020, LITE9001, and UltraLITE2023 (all manufactured by Cardolite Corporation). Note that a cashew oil which is a polymerized product can also be used.

Examples of the cashew oil-modified resins include cashew oil-modified phenolic resins, cashew oil-modified epoxy resins, cashew oil-modified furfural resins, cashew oil-modified benzoxazine resins, urushiol, thitsiol, and laccol. The cashew oil-modified resin preferably contains one, or two or more of those described above.

Examples of commercially available cashew oil-modified phenolic resins include, by product names, PSM-9450, PR-150, PR-217, PR-12686, PR-12686E, PR-12687, PR-13349, PR-YR-170, PR-NR-1, and PR-BSN-21 (all manufactured by Sumitomo Bakelite Co., Ltd.); No. 1321, No. 5208, No. 5610, and 1200W Co., (all manufactured by Cashew Ltd.); A4-1419 (manufactured by DIC Corporation); KG4700G (manufactured by ASAHI YUKIZAI CORPORATION); and ELP83H, ELPC80, ELPC75, and ELC75 (all manufactured by Gun Ei Chemical Industry Co., Ltd.).

Examples of commercially available cashew oil-modified epoxy resins include, by product names, NC-513, NC-513E, NC-514, NC-514S, NC-547, LITE513, LITE513E, and UltraLITE513 (all manufactured by Cardolite Corporation).

Examples of commercially available cashew oil-modified furfural resins include, by a product name, No. 2529 (manufactured by Cashew Co., Ltd.).

Examples of commercially available cashew oil-modified benzoxazine resins include, by a product name, CR-276 (manufactured by Tohoku Chemical Industries, Ltd.).

The component (B) may be used singly, or two or more of the components (B) may be used together. The component (B) preferably has a C10-C20 aliphatic hydrocarbon group because a cured product having excellent adhesiveness and having a lower volume resistance value can be produced. The aliphatic hydrocarbon group refers to a non-aromatic group composed of carbon and hydrogen, and examples thereof include an alkyl group and an alkenyl group. The alkenyl group is not limited to an alkenyl group having one carbon-carbon double bond and includes a group having two or more carbon-carbon double bonds as long as C═C═C— is not formed by adjacent carbon-carbon double bonds. The component (B) more preferably has a C13-C17 aliphatic hydrocarbon group, still more preferably has a C15 aliphatic hydrocarbon group, and particularly preferably has at least one group selected from groups represented by the following formulas (L-1) to (L-4).

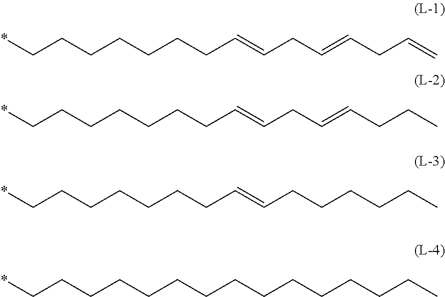 [SMILES: *CCCCCCC/C=C/C/C=C/CC=C ; *CCCCCCC/C=C/C/C=C/CCC ; *CCCCCCC/C=C/CCCCCC ; *CCCCCCCCCCCCCCC]

wherein * represents a bond.

Because a cured product having excellent adhesiveness and having a lower volume resistance value can be produced, among the components (B), cashew oils, cashew oil-modified phenolic resins, cashew oil-modified epoxy resins, cashew oil-modified furfural resins, and cashew oil-modified benzoxazine resins are preferable, more preferably cashew oil-modified phenolic resins and cashew oil-modified epoxy resins. The composition, when containing a xylene resin or a phenolic resin as a component (D), which is an arbitrary component and will be described later, still more preferably contains a cashew oil-modified phenolic resin as the component (B). In addition, the composition, when containing an epoxy resin as a component (D), which is an arbitrary component and will be described later, still more preferably contains a cashew oil-modified epoxy resin as the component (B).

The content of the component (B) in the composition is preferably 0.1 to 15 parts by mass based on 100 parts by mass of the total amount of the composition (in other words, 0.1 to 15% by mass based on the total mass of the composition). When the content of the component (B) is in the above-described range, thereby a cured product having excellent thermal stability and adhesiveness and having a lower volume resistance value can be produced. From this viewpoint, the content of the component (B) in the composition is more preferably 0.3 to 10 parts by mass, still more preferably 0.5 to 7.5 parts by mass, based on 100 parts by mass of the total amount of the composition.

The component (C) is a curing agent. The type of the curing agent is not particularly limited, and generally known curing agents can be used. Examples of the curing agent include a latent curing agent, an acid anhydride, a polyamine compound, a polyphenol compound, and a cationic photoinitiator. The curing agent is for curing the component (B), and when the composition also contains a component (D), which will be described later, the curing agent is also for curing the component (D).

Examples of the latent curing agent include dicyandiamide, a hydrazide, an imidazole compound, an amine adduct, a sulfonium salt, an onium salt, a ketimine, an acid anhydride, and a tertiary amine. These latent curing agents are preferably used because a composition containing an additive for producing a cured product can be made into a one-component type curable composition that is easy to handle.

Examples of the imidazole compound include imidazoles, such as 2-methylimidazole, 2-phenylimidazole, 2-undecylimidazole, 2-heptadecylimidazole, 2-phenyl-4-methylimidazole, 2-ethyl-4-methylimidazole, 2-phenyl-4-methyl-5-hydroxymethylimidazole, 1-benzyl-2-phenylimidazole, 1-benzyl-2-methylimidazole, 1-cyanoethyl-2-methylimidazole, 1-cyanoethyl-2-phenylimidazole, 1-cyanoethyl-2-undecylimidazole, 2,4-diamino-6 (2′-methylimidazole (1′)) ethyl-s-triazine, 2,4-diamino-6 (2′-undecylimidazole (1′)) ethyl-s-triazine, 2,4-diamino-6 (2′-ethyl, 4-methylimidazole (1′)) ethyl-s-triazine, isocyanuric acid adduct of 2,4-diamino-6 (2′-methylimidazole (1′)) ethyl-s-triazine, 2:3 adduct of 2-methylimidazole and isocyanuric acid, isocyanuric acid adduct of 2-phenylimidazole, 2-phenyl-3,5-dihydroxymethylimidazole, 2-phenyl-4-hydroxymethyl-5-methylimidazole, and 1-cyanoethyl-2-phenyl-3,5-dicyanoethoxymethylimidazole; and salts of these imidazoles and polyvalent carboxylic acids, such as phthalic acid, isophthalic acid, terephthalic acid, trimellitic acid, pyromellitic acid, naphthalene dicarboxylic acid, maleic acid, and oxalic acid. Among others, imidazole compounds having an alkyl group are preferable, particularly preferably 2-ethyl-4-methylimidazole and 2-phenyl-4-methyl-5-hydroxymethylimidazole, from the viewpoint of curing performance and storage stability. Examples of commercially available imidazole compounds include, by product names, 2P4MHZ-PW, 2P4MHZ, and 2E4MZ (all manufactured by SHIKOKU CHEMICALS CORPORATION).

Examples of the acid anhydride include phthalic anhydride, trimellitic anhydride, pyromellitic anhydride, tetrahydrophthalic anhydride, hexahydrophthalic anhydride, maleic anhydride, succinic anhydride, and 2,2-bis (3,4-dicarboxyphenyl)-1,1,1,3,3,3-hexafluoropropane dianhydride.

Examples of the polyamine compound include aliphatic polyamines, such as ethylenediamine, diethylenetriamine, and triethylenetetramine; alicyclic polyamines, as mencene diamine, isophoronediamine, bis (4-amino-3-methylcyclohexyl) methane, bis (aminomethyl) cyclohexane, and 3,9-bis (3-aminopropyl)-2,4,8,10-tetraoxaspiro [5,5]undecane; aliphatic polyamines having an aromatic ring, such as m-xylenediamine; and aromatic polyamines, such as m-phenylenediamine, 2,2-bis (4-aminophenyl) propane, diaminodiphenylmethane, diaminodiphenylsulfone, α, α-bis (4-aminophenyl)-p-diisopropylbenzene, and 2,2-bis (4-aminophenyl)-1,1,1,3,3,3-hexafluoropropane.

Examples of the polyphenol compound include phenol novolac, o-cresol novolac, t-butylphenol novolac, dicyclopentadiene cresol, terpene diphenol, terpene dicatechol, 1,1,3-tris (3-t-butyl-4-hydroxy-6-methylphenyl) butane, butylidene bis (3-t-butyl-4-hydroxy-6-methylphenyl), and 2,2-bis (4-hydroxyphenyl)-1, 1,1,3,3,3-hexafluoropropane.

Because a cured product having excellent heat resistance can be produced, a latent curing agent is preferably used as the component (C), and among others, an imidazole compound is more preferably used.

The content of the component (C) in the composition is preferably 0.1 to 5 parts by mass based on 100 parts by mass of the total amount of the composition (in other words, 0.1 to 5% by mass based on the total mass of the composition). From the viewpoint of curing performance and heat resistance, the content of the component (C) in the composition is more preferably 0.3 to 4 parts by mass, still more preferably 0.5 to 3 parts by mass, based on 100 parts by mass of the total amount of the composition.

The composition of one embodiment of the present invention preferably further contains a component (D): at least one resin selected from the group consisting of xylene resins, phenolic resins, and epoxy resins (herein, also simply referred as “component (D);” however, excluding the component (B)). By using the components (A) to (C) and the component (D) in combination, a composition that makes it possible to produce a cured product having excellent adhesiveness and having a lower volume resistance value can be obtained. Note that the xylene resins refer to resins having a xylene structure in the structure thereof and derivatives thereof. The phenolic resins refer to resins having a phenol structure in the structure thereof and derivatives thereof. The epoxy resins refer to resins having an epoxy structure in the structure thereof and derivatives thereof.

Examples of the xylene resins include resol type xylene resins, alkylphenol-modified xylene resins, novolac type xylene resins, polyol-modified xylene resins, and ethylene oxide-modified xylene resins. Among others, resol type xylene resins are preferable because a cured product having excellent adhesiveness and having a lower volume resistance value can be produced.

Commercially available xylene resins can also be used. Examples of commercially available xylene resins include resol type xylene resins (trade names: PR-1440 and PR-1440M, manufactured by Fudow Company Limited), alkylphenol-modified xylene resins (trade names: GHP-150, HP-120, HP-100, HP-210, and HP-70, manufactured by Fudow Company Limited), novolac type xylene resins (trade names: NP-100, GP-212, P-100, GP-200, and HP-30, manufactured by Fudow Company Limited), a polyol-modified xylene resin (trade name: K-100, manufactured by Fudow Company Limited), and an ethylene oxide-modified xylene resin (trade name: L5, manufactured by Fudow Company Limited). Note that resins having a xylene structure and a phenol structure in the structure thereof are preferable because a cured product having excellent adhesiveness and having a lower volume resistance value can be produced.

Examples of the phenolic resins include novolac type phenolic resins and resol type phenolic resins. Among others, resol type phenolic resins are preferably because a cured product having excellent adhesiveness and having a lower volume resistance value can be produced.

Commercially available phenolic resins can also be used. Examples of the commercially available phenolic resins include powder phenolic resins (trade names: RESITOP PGA-4528, PGA-2473, PGA-4704, and PGA-4504, manufactured by Gun Ei Chemical Industry Co., Ltd., trade names: SUMILITERESIN PR-UFC-504, PR-EPN, PR-ACS-100, PR-ACS-150, PR-12687, PR-13355, PR-16382, PR-217, PR-310, PR-311, PR-50064, PR-50099, PR-50102, PR-50252, PR-50395, PR-50590, PR-50590B, PR-50699, PR-50869, PR-51316, PR-51326B, PR-51350B, PR-51510, PR-51541B, PR-51794, PR-51820, PR-51939, PR-53153, PR-53364, PR-53497, PR-53724, PR-53769, PR-53804, PR-54364, PR-54458A, PR-54545, PR-55170, PR-8000, PR-FTZ-1, and PR-FTZ-15, manufactured by Sumitomo Bakelite Co., Ltd.), flake phenolic resins (trade names: SUMILITERESIN PR-12686R, PR-13349, PR-50235A, PR-51363F, PR-51494G, PR-51618G, PR-53194, PR-53195, PR-54869, PR-F-110, PR-F-143, PR-F-151F, PR-F-85G, PR-HF-3, and PR-HF-6, manufactured by Sumitomo Bakelite Co., Ltd.), liquid phenolic resins (trade names: SUMILITERESIN PR-50087, PR-50607B, PR-50702, PR-50781, PR-51138C, PR-51206, PR-51663, PR-51947A, PR-53123, PR-53338, PR-53365, PR-53717, PR-54135, PR-54313, PR-54562, PR-55345, PR-940, PR-9400, and PR-967, manufactured by Sumitomo Bakelite Co., Ltd.), resol type liquid phenolic resins (trade names: RESITOP PL-4826, PL-2390, PL-4690, PL-3630, PL-4222, PL-4246, PL-2211, PL-3224, PL-4329, and PL-5208, manufactured by Gun Ei Chemical Industry Co., Ltd., trade names: SUMILITERESIN PR-50273, PR-51206, PR-51781, PR-53056, PR-53311, PR-53416, PR-53570, and PR-54387, manufactured by Sumitomo Bakelite Co., Ltd.), particulate phenolic resins (trade names: Bellpearl R800, R700, R600, R200, R100, S830, S870, S890, S895, S290, and S190, manufactured by AIR WATER INC.), spherical phenolic resins (trade names: Marilin GU-200, FM-010, FM-150, HF-008, HF-015, HF-075, HF-300, HF-500, and HF-1500, manufactured by Gun Ei Chemical Industry Co., Ltd.), and solid phenolic resins (trade names: RESITOP PS-2601, PS-2607, PS-2655, PS-2768, PS-2608, PS-4609, PSM-2222, PSK-2320, and PS-6132, manufactured by Gun Ei Chemical Industry Co., Ltd.). Note that resins each having a xylene structure in the structure thereof and resins each having a phenol structure in the structure thereof are preferable because a cured product having excellent adhesiveness and having a lower volume resistance value can be produced.

Examples of the epoxy resins include bisphenol A type epoxy resins, bisphenol F type epoxy resins, bisphenol AD type epoxy resins, bisphenol A-PO type epoxy resins, phenol novolac type epoxy resins, cresol novolac type epoxy resins, glycidylamine type epoxy resins, dicyclopentadiene methacrylate type epoxy resins, urethane-modified epoxy resins, rubber-modified epoxy resins, and chelate-modified epoxy resins. Among others, bisphenol A type epoxy resins, bisphenol F type epoxy resins, dicyclopentadiene methacrylate type epoxy resins, and chelate-modified epoxy resins are preferable, more preferably dicyclopentadiene methacrylate type epoxy resins, and chelate-modified epoxy resins, and still more preferably chelate-modified epoxy resins, because a cured product having excellent adhesiveness and having a lower volume resistance value can be produced. In addition, the viscosity of the epoxy resins at 25° C. is preferably 100 mPa·s or higher because a cured product having excellent adhesiveness and having a lower volume resistance value can be produced.

Commercially available epoxy resins can also be used. Examples of the commercially available epoxy resins include, by product names, bisphenol A type epoxy resins, such as AER-X8501 (manufactured by Asahi Kasei Corp.), and R-301 and YL-980 (both manufactured by Mitsubishi Chemical Corporation); bisphenol F type epoxy resins, such as YDF-170 (manufactured by NIPPON STEEL Chemical & Material Co., Ltd.), and YL-983 and YL-983U (both manufactured by Mitsubishi Chemical Corporation); epoxy resins having a glycidyl group (Denacol EX-121, Denacol EX-171, Denacol EX-192, Denacol EX-211, Denacol EX-212, Denacol EX-313, Denacol EX-314, Denacol EX-321, Denacol EX-411, Denacol EX-421, Denacol EX-512, Denacol EX-521, Denacol EX-611, Denacol EX-612, Denacol EX-614, Denacol EX-622, Denacol EX-810, Denacol EX-811, Denacol EX-850, Denacol EX-851, Denacol EX-821, Denacol EX-830, Denacol EX-832, Denacol EX-841, Denacol EX-861, Denacol EX-911, Denacol EX-941, Denacol EX-920, Denacol EX-931, Denacol EX-145, Denacol EX-146, Denacol EX-147, Denacol EX-201, Denacol EX-711, Denacol EX-721, Oncoat EX-1020, Oncoat EX-1030, Oncoat EX-1040, Oncoat EX-1050, Oncoat EX-1051, Oncoat EX-1010, Oncoat EX-1011, and Oncoat 1012 (all manufactured by Nagase ChemteX Corporation), Epolite M-1230, Epolite 40E, Epolite 100E, Epolite 200E, Epolite 400E, Epolite 70P, Epolite 200P, Epolite 400P, Epolite 1500NP, Epolite 1600, Epolite 80MF, and Epolite 100MF (all manufactured by Kyoeisha Chemical Co., Ltd.), OGSOL PG-100, OGSOL EG-200, OGSOL EG-210, and OGSOL EG-250 (all manufactured by Osaka Gas Chemical Co., Ltd.), HP4032, HP4032D, and HP4700 (all manufactured by DIC Corporation), ESN-475V (manufactured by NIPPON STEEL Chemical & Material Co., Ltd.), 152, 154, 157, S70, and YX8800 (all manufactured by Mitsubishi Chemical Corporation), and ADEKA RESIN EP-4088S, ADEKA RESIN EP-4100, ADEKA RESIN EP-4100G, ADEKA RESIN EP-4100E, ADEKA RESIN EP-4100L, ADEKA RESIN EP-4100TX, ADEKA RESIN EP-4000, ADEKA RESIN EP-4005, ADEKA RESIN EP-4080E, ADEKA RESIN EP-4082HT, ADEKA RESIN EP-4901, ADEKA RESIN EP-4901E, ADEKA RESIN EP-49-10P, ADEKA RESIN EP-49-10P2, and ADEKA RESIN EP-49-23 (all manufactured by ADEKA CORPORATION)); polyalkylene oxylated bisphenol A type epoxy resins, such as EXA-4816 and EXA-4822 (both manufactured by DIC Corporation); bisphenol AD type epoxy resins, such as R-1710 (manufactured by Mitsui Chemicals, Inc.); phenol novolac type epoxy resins, such as N-730S (manufactured by DIC Corporation) and Quatrex-2010 (manufactured by The Dow Chemical Company); cresol novolac type epoxy resins, such as YDCN-702S (manufactured by NIPPON STEEL Chemical & Material Co., Ltd.) and EOCN-100 (manufactured by Nippon Kayaku Co., Ltd.); polyfunctional epoxy resins, such as EPPN-501 (manufactured by Nippon Kayaku Co., Ltd.), TACTIX-742 (manufactured by The Dow Chemical Company), VG-3010 (manufactured by Mitsui Chemicals, Inc.), and 1032S and 1032-H60 (both manufactured by Mitsubishi Chemical Corporation); epoxy resins having a naphthalene skeleton, such HP-4032 (manufactured by DIC Corporation); alicyclic epoxy resins, such as EHPE-3150 and CEL-3000 (both manufactured by Daicel Corporation), DME-100 (manufactured by New Japan Chemical Co., Ltd.), and EX-216L (manufactured by Nagase ChemteX Corporation); aliphatic epoxy resins, such as W-100 (manufactured by NIPPON STEEL Chemical & Material Co., Ltd.); amine type epoxy resins, h as ELM-100 (manufactured by SUMITOMO CHEMICAL COMPANY, LIMITED), YH-434L (manufactured by NIPPON STEEL Chemical & Material Co., Ltd.), TETRAD-X and TETRAD-C(both manufactured by MITSUBISHI GAS CHEMICAL COMPANY, INC.), and 630 and 630LSD (both manufactured by Mitsubishi Chemical Corporation); resorcin type epoxy resins, such as Denacol EX-201 (manufactured by Nagase ChemteX Corporation); neopentyl glycol type epoxy resins, such as Denacol EX-211 (manufactured by Nagase ChemteX Corporation); hexanedienyl glycol type epoxy resins, such as Denacol EX-212 (manufactured by Nagase ChemteX Corporation); ethylene/propylene glycol type epoxy resins, such as Denacol EX series (EX-810, 811, 850, 851, 821, 830, 832, 841, and 861 (all manufactured by Nagase ChemteX Corporation)); and vinyl ether type epoxy resins such as EXA-4850-1000 and EXA-4850-150 (both manufactured by DIC Corporation). Note that epoxy resin diluents which can be used as a component (E): solvent, which will be described later, are not included in the epoxy resins which can be used as the component (D).

The content of the component (D) in the composition is preferably 30 parts by mass or less based on 100 parts by mass of the total amount of the composition (in other words, 30% by mass or less based on the total mass of the composition). When the content of the component (D) is in the above-described range, thereby a cured product having excellent adhesiveness and having a lower volume resistance value can be produced. From this viewpoint, the content of the component (D) in the composition is more preferably 1 to 25 parts by mass, still more preferably 5 to 20 parts by mass, based on 100 parts by mass of the total amount of the composition.

The composition of one embodiment of the present invention preferably further contains a component (E): solvent (hereinafter, also simply referred to as “component (E)”). By using the above-described components (A) to (C) and the component (E) in combination, a composition that makes it possible to produce a cured product having excellent adhesiveness and having a lower volume resistance value can be obtained.

Examples of the solvent include an alcohol-based solvent, a diol-based solvent, a ketone-based solvent, an ester-based solvent, an ether-based solvent, an aliphatic or alicyclic hydrocarbon-based solvent, an aromatic hydrocarbon-based solvent, a hydrocarbon solvent having a cyano group, and an epoxy resin diluent. Among these, the solvent is preferably an ester-based solvent or an epoxy resin diluent because a cured product having excellent adhesiveness and having a lower volume resistance value can be produced. The composition, when containing a xylene resin or a phenolic resin as the above-described component (D), more preferably contains an ester-based solvent as the component (E). The composition, when containing an epoxy resin as the above-described component (D), more preferably contains an epoxy resin-based diluent as the component (E). Note that the component (E) is liquid at 25° C. under atmospheric pressure. The component (E) is contained as a component different from the components (A) to (D), and even when there is a liquid component in the components (B) to (D), the component does not fall into the category of the component (E).

Examples of the alcohol-based solvent include methanol, ethanol, propanol, isopropanol, 1-butanol, isobutanol, 2-butanol, t-butanol, pentanol, isopentanol, 2-pentanol, neopentanol, t-pentanol, hexanol, 2-hexanol, heptanol, 2-heptanol, octanol, 2-ethylhexanol, 2-octanol, cyclopentanol, cyclohexanol, cycloheptanol, methylcyclopentanol, methylcyclohexanol, methylcycloheptanol, benzyl alcohol, ethylene glycol monoacetate, ethylene glycol monoethyl ether, ethylene glycol monophenyl ether, ethylene glycol monobutyl ether, ethylene glycol monomethyl ether, propylene glycol monomethyl ether, propylene glycol monoethyl ether, diethylene glycol monomethyl ether, diethylene glycol monoethyl ether, dipropylene glycol monomethyl ether, dipropylene glycol monoethyl ether, dipropylene glycol monobutyl ether, 2-(2-methoxyethoxy) ethanol, 2-(N, N-dimethylamino) ethanol, and 3-(N, N-dimethylamino) propanol. Examples of the diol-based solvent include ethylene glycol, propylene glycol, 1,2-butanediol, 1,3-butanediol, 1,4-butanediol, 1,5-pentanediol, neopentyl glycol, isoprene glycol (3-methyl-1,3-butanediol), 1,2-hexanediol, 1,6-hexanediol, 3-methyl-1,5-pentanediol, 1,2-octanediol, octanediol (2-ethyl-1,3-hexanediol), 2-butyl-2-ethyl-1,3-propanediol, 2,5-dimethyl-2,5-hexanediol, 1,2-cyclohexanediol, 1,4-cyclohexanediol, and 1,4-cyclohexanedimethanol.

Examples of the ketone-based solvent include acetone, ethyl methyl ketone, methyl butyl ketone, methyl isobutyl ketone, ethyl butyl ketone, dipropyl ketone, diisobutyl ketone, methyl amyl ketone, cyclohexanone, and methylcyclohexanone.

Examples of the ester-based solvent include methyl formate, ethyl formate, methyl acetate, ethyl acetate, isopropyl acetate, butyl acetate, isobutyl acetate, sec-butyl acetate, acetate, amyl acetate, isoamyl acetate, t-amyl acetate, phenyl acetate, methyl propionate, ethyl propionate, isopropyl propionate, butyl propionate, isobutyl propionate, sec-butyl propionate, t-butyl propionate, amyl propionate, isoamyl propionate, t-amyl propionate, phenyl propionate, methyl 2-ethylhexanoate, ethyl 2-ethylhexanoate, propyl 2-ethylhexanoate, isopropyl 2-ethylhexanoate, butyl 2-ethylhexanoate, methyl lactate, ethyl lactate, methyl methoxypropionate, methyl ethoxypropionate, ethyl methoxypropionate, ethyl ethoxypropionate, ethylene glycol monomethyl ether acetate, diethylene glycol monomethyl ether acetate, ethylene glycol monoethyl ether acetate, ethylene glycol monopropyl ether acetate, ethylene glycol monoisopropyl ether acetate, ethylene glycol monobutyl ether acetate, ethylene glycol mono-sec-butyl ether acetate, ethylene glycol monoisobutyl ether acetate, ethylene glycol mono-t-butyl ether acetate, diethylene glycol monobutyl ether acetate, propylene glycol monomethyl ether acetate, propylene glycol monoethyl ether acetate, propylene glycol monopropyl ether acetate, propylene glycol monoisopropyl ether acetate, propylene glycol monobutyl ether acetate, propylene glycol mono-sec-butyl ether acetate, propylene glycol monoisobutyl ether acetate, propylene glycol mono-t-butyl ether acetate, butylene glycol monomethyl ether acetate, butylene glycol monoethyl ether acetate, butylene glycol monopropyl ether acetate, butylene glycol monoisopropyl ether acetate, butylene glycol monobutyl ether acetate, butylene glycol mono-sec-butyl ether acetate, butylene glycol monoisobutyl ether acetate, butylene glycol mono-t-butyl ether acetate, methyl acetoacetate, ethyl acetoacetate, methyl oxobutanoate, ethyl oxobutanoate, γ-lactone, and δ-lactone.

Examples of the ether-based solvent include tetrahydrofuran, tetrahydropyran, morpholine, ethylene glycol dimethyl ether, diethylene glycol dimethyl ether, triethylene glycol dimethyl ether, dibutyl ether, diethyl ether, and dioxane.

Examples of the aliphatic or alicyclic hydrocarbon-based solvent include pentane, hexane, cyclohexane, methylcyclohexane, dimethylcyclohexane, ethylcyclohexane, heptane, decalin, and solvent naphtha.

Examples of the aromatic hydrocarbon-based solvent include benzene, toluene, ethylbenzene, xylene, mesitylene, diethylbenzene, cumene, isobutylbenzene, cymene, and tetralin.

Examples of the hydrocarbon solvent having a cyano group include 1-cyanopropane, 1-cyanobutane, 1-cyanohexane, cyanocyclohexane, cyanobenzene, 1,3-dicyanopropane, 1,4-dicyanobutane, 1,6-dicyanohexane, 1,4-dicyanocyclohexane, and 1,4-dicyanobenzene.

Commercially available epoxy resin diluents can be used. Examples of the commercially available epoxy resin diluents include, by product names, ADEKA RESIN ED-501, ADEKA RESIN ED-502, ADEKA RESIN ED-502S, ADEKA RESIN ED-509E, ADEKA RESIN ED-509S, ADEKA RESIN ED-529, ADEKA RESIN ED-518, ADEKA RESIN ED-503, ADEKA RESIN ED-503G, ADEKA RESIN ED-506, ADEKA RESIN ED-523T, ADEKA RESIN ED-515, ADEKA RESIN ED-505, ADEKA RESIN ED-505R, ADEKA RESIN ED-508, and ADEKA RESIN ED-512X (all manufactured by ADEKA CORPORATION). The epoxy resin diluent is preferably a monofunctional or difunctional epoxy resin diluent because a cured product having excellent adhesiveness and having a lower volume resistance value can be produced. In addition, the viscosity of the epoxy resin diluents at 25° C. is preferably lower than 100 mPa·s because a cured product having excellent adhesiveness and having a lower volume resistance value can be produced.

The content of the component (E) in the composition is preferably 20 parts by mass or less based on 100 parts by mass of the total amount of the composition (in other words, 20% by mass or less based on the total mass of the composition). When the content of the component (E) is in the above-described range, thereby a cured product having excellent adhesiveness and having a lower volume resistance value can be produced. From this viewpoint, the content of the component (E) in the composition is more preferably 0.5 to 15 parts by mass, still more preferably 1 to 12 parts by mass, based on 100 parts by mass of the total amount of the composition.

Next, a method for producing a cured product, which is one embodiment of the present invention, will be described. The method for producing a cured product of the present embodiment includes: a coating step of coating a substrate with the above-described composition; and a curing step of heating the substrate coated with the composition to cure the composition. In the curing step, the substrate coated with the composition is preferably heated at 50 to 250° C. because a cured product having a more satisfactory electric conductivity can be obtained, and the substrate is more preferably heated at 100 to 200° C. Further, in the curing step, the substrate coated with the composition is preferably heated for 1 to 200 minutes, more preferably 10 to 60 minutes, because a cured product having high heat resistance can be obtained. Note that, if necessary, the method for producing a cured product of the present embodiment may further include, prior to the curing step, a drying step of keeping the substrate or the substrate coated with the composition at 50 to 150° C. to volatilize a low-boiling-point component, such as an organic solvent.

Examples of the substrate include a resin substrate, a glass substrate, and a ceramic substrate. Examples of the material for the resin substrate include a polyimide, a polyester, an aramid, polyethylene terephthalate (PET), and Teflon (R). Examples of the material for the ceramic substrate include alumina and alumina zirconia. Examples of the type of the glass substrate include a glass epoxy substrate and a glass-composite substrate.

Examples of the method (coating method) for coating the substrate with the composition in the coating step include a spin coating method, a dipping method, a spray coating method, a mist coating method, a flow coating method, a curtain coating method, a roll coating method, a knife coating method, a bar coating method, a slit coating method, a screen printing method, a gravure printing method, an offset printing method, an inkjet method, and brush coating.

To make the film thickness of a cured product to be produced as required, steps from the coating step to an optional step can be repeated multiple times. For example, all the steps from the coating step to the curing step may be repeated multiple times, or the coating step and the drying step may be repeated multiple times.

By curing the composition, a cured product which is one embodiment of the present invention can be obtained. Examples of the application of the cured product of the present embodiment include an electrically conductive layer, an electrode film, and wiring.

As described above in detail, the present embodiment can take the following forms.
[1] A composition comprising a component (A): at least metal particles selected from the group consisting of copper particles and silver particles, a component (B): at least one cashew component selected from the group consisting of cashew oils and cashew oil-modified resins, and a component (C): a curing agent.
[2] The composition according to [1], wherein the content of the component (B) is 0.1 to 15 parts by mass, and the content of the component (C) is 0.1 to 5 parts by mass, based on 100 parts by mass of the total amount of the composition.
[3] The composition according to [1] or [2], further comprising a component (D): at least one resin selected from the group consisting of xylene resins, phenolic resins, and epoxy resins, excluding the component (B).
[4] The composition according to [3], wherein the content of the component (D) is 30 parts by mass or less based on 100 parts by mass of the total amount of the composition.
[5] The composition according to any one of [1] to [4], further comprising a component (E): a solvent.
[6] The composition according to [5], wherein the content of the component (E) is 20 parts by mass or less based on 100 parts by mass of the total amount of the composition.
[7] The composition according to any one of [1] to [6], wherein the component (A) consists of metal particles surface-treated with a fatty acid.
[8] A method for producing a cured product, the method comprising: a coating step of coating a substrate with the composition according to any one of [1] to [7]; and a curing step of heating the substrate coated with the composition to cure the composition.
[9] The method for producing a cured product according to
[8], wherein the substrate coated with the composition is heated at 50 to 250ºC for 1 to 200 minutes.

A cured product obtained by curing the composition according to any one of [1] to [7].

### EXAMPLES

Hereinafter, the present invention will be described in more detail with reference to Examples and Comparative Examples. The present invention, however, is not limited to the following Examples and the like.

### <Component (A)>

As the component (A) (metal particles), A-1 and A-2, shown below, were provided. Note that A-1 and A-2 provided were subjected to a surface treatment with stearic acid and then dried.

A-1: Granular copper particles (D₅₀: 3.5 μm, trade name “1300Y,” manufactured by MITSUI MINING & SMELTING CO., LTD.)

A-2: Granular silver particles (D₅₀: 2.5 μm, trade name “SPN20J,” manufactured by MITSUI MINING & SMELTING CO., LTD.)

### <Component (B)>

As the component (B) (cashew component), B-1 to B-8, shown below, were provided. Note that each of B-1 to B-8 has at least one group selected from the groups represented by the above-described formulas (L-1) to (L-4).

B-1: Cashew oil (trade name “CX-1000,” manufactured by Cashew Co., Ltd.)

B-2: Cashew oil (trade name “No. 930,” manufactured by Cashew Co., Ltd.)

B-3: Cashew oil-modified phenolic resin (trade name “ELP83H,” manufactured by Gun Ei Chemical Industry Co., Ltd.)

B-4: Cashew oil-modified phenolic resin (trade name “No. 5208,” manufactured by Cashew Co., Ltd.)

B-5: Cashew oil-modified furfural resin (trade name “No. 2529,” manufactured by Cashew Co., Ltd.)

B-6: Cashew oil-modified benzoxazine resin (trade name “CR-276,” manufactured by Tohoku Chemical Industries, Ltd.)

B-7: Cashew oil-modified epoxy resin (trade name “NC-513-E,” manufactured by Cardolite Corporation)

B-8: Cashew oil-modified epoxy resin (trade name “NC-547,” manufactured by Cardolite Corporation)

### <Component (C)>

As the component (C) (curing agent), C-1 and C-2, shown below, were provided.

C-1: Imidazole compound (trade name “2 P4MHZ-PW,” manufactured by SHIKOKU CHEMICALS CORPORATION)

C-2: Imidazole compound (trade name “2E4MZ,” manufactured by SHIKOKU CHEMICALS CORPORATION)

### <Component (D)>

As the component (D) (resin), D-t to D-7, shown below, were provided.

D-1: Xylene resin (trade name “PR-1440,” manufactured by Fudow Company Limited)

D-2: Phenolic resin (trade name “PL-2211,” manufactured by Gun Ei Chemical Industry Co., Ltd.)

D-3: Epoxy resin (trade name “ADEKA RESIN EP-49-10P,” manufactured by ADEKA CORPORATION)

D-4: Epoxy resin (trade name “ADEKA RESIN EP-49-23,” manufactured by ADEKA CORPORATION)

D-5: Epoxy resin (trade name “ADEKA RESIN EP-4100E,” manufactured by ADEKA CORPORATION)

D-6: Epoxy resin (trade name “ADEKA RESIN EP-4901E,” manufactured by ADEKA CORPORATION)

D-7: Epoxy resin (trade name “ADEKA RESIN EP-4088S,” manufactured by ADEKA CORPORATION)

### <Component (E)>

As the component (E) (solvent), E-1 and E-2, shown below, were provided.

E-1: Diethylene glycol monobutyl ether acetate

E-2: Epoxy resin diluent (trade name “ADEKA RESIN ED-503G,” manufactured by ADEKA CORPORATION)

### <Composition>

### Examples 1 to 16 and Comparative Examples 1 to 4

Compositions No. 1 to 16 of Examples and compositions 1 to 4 of Comparative Examples were produced by mixing respective components so as to make the formulation as shown in Table 1.

TABLE 1

| | | Component (A) | Component (B)-1 | Component (B)-2 | Component (C) | Component (D) | Component (E) |
|---|---|---|---|---|---|---|---|
| | Composition* | parts by mass | parts by mass | parts by mass | parts by mass | parts by mass | parts by mass |
| Example 1 | Composition | A-1 | B-1 | — | C-1 | D-1 | E-1 |
| | No. 1 | 92.5 | 3.5 | — | 0.5 | 2 | 1.5 |
| Example 2 | Composition | A-1 | B-2 | — | C-1 | D-2 | E-1 |
| | No. 2 | 74 | 5 | — | 1 | 10 | 10 |
| Example 3 | Composition | A-1 | B-3 | — | C-1 | D-1 | E-1 |
| | No. 3 | 77 | 2.5 | — | 1.5 | 11 | 8 |
| Example 4 | Composition | A-1 | B-4 | — | C-1 | D-1 | E-1 |
| | No. 4 | 79 | 2 | — | 1 | 10 | 8 |
| Example 5 | Composition | A-1 | B-4 | — | C-1 | D-1 | E-1 |
| | No. 5 | 81 | 1.5 | — | 0.5 | 8 | 9 |
| Example 6 | Composition | A-1 | B-5 | — | C-1 | D-2 | E-1 |
| | No. 6 | 77 | 3 | — | 5 | 10 | 5 |
| Example 7 | Composition | A-1 | B-6 | — | C-1 | D-1 | E-1 |
| | No. 7 | 78.8 | 3 | — | 0.2 | 8 | 10 |
| Example 8 | Composition | A-1 | B-7 | — | C-2 | D-3 | E-2 |
| | No. 8 | 87.5 | 2.5 | — | 1 | 7 | 2 |
| Example 9 | Composition | A-1 | B-7 | — | C-2 | D-4 | E-2 |
| | No. 9 | 88 | 2 | — | 1.5 | 6 | 2.5 |
| Example 10 | Composition | A-1 | B-7 | — | C-2 | D-5 | E-2 |
| | No. 10 | 86.5 | 2.5 | — | 1 | 8 | 2 |
| Example 11 | Composition | A-1 | B-7 | — | C-2 | D-6 | E-2 |
| | No. 11 | 87 | 2.5 | — | 1.5 | 7 | 2 |
| Example 12 | Composition | A-1 | B-7 | — | C-2 | D-7 | E-2 |
| | No. 12 | 88.1 | 2.2 | — | 1 | 6.5 | 2.2 |
| Example 13 | Composition | A-1 | B-7 | B-8 | C-2 | D-7 | E-2 |
| | No. 13 | 88 | 2.5 | 4.5 | 1 | 2 | 2 |
| Example 14 | Composition | A-1 | B-7 | — | C-2 | — | E-2 |
| | No. 14 | 93 | 3 | — | 1 | — | 3 |
| Example 15 | Composition | A-2 | B-4 | — | C-1 | D-1 | E-1 |
| | No. 15 | 85 | 2 | — | 1 | 10 | 2 |
| Example 16 | Composition | A-2 | B-7 | — | C-2 | D-6 | E-2 |
| | No. 16 | 88 | 2.5 | — | 1 | 6.5 | 2 |
| Comparative | Composition 1 | A-1 | — | — | C-1 | D-1 | E-1 |
| Example 1 | | 88 | — | — | 1 | 8 | 3 |
| Comparative | Composition 2 | A-1 | — | — | C-2 | D-7 | E-2 |
| Example 2 | | 87 | — | — | 1 | 10 | 2 |
| Comparative | Composition 3 | A-1 | B-1 | — | — | D-1 | E-1 |
| Example 3 | | 89 | 2 | — | — | 6.5 | 2.5 |
| Comparative | Composition 4 | A-2 | — | — | C-1 | D-2 | E-1 |
| Example 4 | | 90 | — | — | 1 | 7 | 2 |

*¹ Compositions No. 1 to No. 16 are of Examples, Compositions 1 to 4 are of Comparative Examples.

<Production of Cured Product a>

Each of compositions No. 1 to 16 of Examples and compositions 1 to 4 of Comparative Examples was separately applied on a glass substrate by a bar coating method such that the length, the width, and the thickness were 3 cm, 3 cm, and 30 μm, respectively. The applied compositions were subjected to baking by heating at 200° C. for 20 minutes in the air to give thin film-like cured products No. 1a to 16a of Examples and thin film-like cured products 1a to 4a of Comparative Examples.

### <Evaluation of Volume Resistance Value>

### Evaluation Examples 1 to 16 and Comparative Evaluation Examples 1 to 4

The volume resistance value was measured for cured products No. 1a to 16a of Examples and cured products 1a to 4a of Comparative Examples by a four point probe method using a high-precision resistometer (product name, “Loresta-GP,” manufactured by Nittoseiko Analytech Co., Ltd.). The results are shown in Table 2.

<Production of Cured Product b>

Each of compositions No. 1 to 16 of Examples and compositions 1 to 4 of Comparative Examples was separately applied on a copper substrate by a bar coating method such that the length, the width, and the thickness were 3 cm, 3 cm, and 30 μm, respectively. The applied compositions were subjected to baking by heating at 200° C. for 20 minutes in the air to give thin film-like cured products No. 1b to 16b of Examples and thin film-like cured products 1b to 4b of Comparative Examples.

### <Evaluation of Adhesiveness>(Cross Cut Method, Tape Peel Test)

On each of cured products No. 1b to 16b of Examples and cured products 1b to 4b of Comparative Examples, 11 cuts were made using a cutter knife and a cross-cut guard to prepare 100 grids. Thereafter, a tape was strongly pressed to the cured product, and the edge of the tape was peeled at an angle of 45° at once to evaluate the adhesiveness according to whether or not the cross-cut parts were peeled following the evaluation criteria described below. The results are shown in Table 2

### Evaluation Criteria

Good: Peeling is not recognized, and therefore the cured product is superior in adhesiveness.
Fair: Peeling is recognized at 1 to 10 grids, and therefore the cured product is somewhat inferior in adhesiveness.
Poor: Peeling was recognized at 11 or more grids, and therefore the cured product is inferior in adhesiveness.

TABLE 2

| | | Volume resistance | | |
|---|---|---|---|---|
| | Cured product a*¹ | value (Ω · cm) | Cured product b*² | Adhesiveness |
| Evaluation Example 1 | Cured product No. 1a | 5.5 × 10⁻⁴ | Cured product No. 1b | Good |
| Evaluation Example 2 | Cured product No. 2a | 4.8 × 10⁻⁴ | Cured product No. 2b | Good |
| Evaluation Example 3 | Cured product No. 3a | 3.0 × 10⁻⁴ | Cured product No. 3b | Good |
| Evaluation Example 4 | Cured product No. 4a | 1.5 × 10⁻⁴ | Cured product No. 4b | Good |
| Evaluation Example 5 | Cured product No. 5a | 1.7 × 10⁻⁴ | Cured product No. 5b | Good |
| Evaluation Example 6 | Cured product No. 6a | 4.5 × 10⁻⁴ | Cured product No. 6b | Good |
| Evaluation Example 7 | Cured product No. 7a | 3.4 × 10⁻⁴ | Cured product No. 7b | Good |
| Evaluation Example 8 | Cured product No. 8a | 1.0 × 10⁻⁴ | Cured product No. 8b | Good |
| Evaluation Example 9 | Cured product No. 9a | 3.6 × 10⁻⁴ | Cured product No. 9b | Good |
| Evaluation Example 10 | Cured product No. 10a | 6.2 × 10⁻⁴ | Cured product No. 10b | Good |
| Evaluation Example 11 | Cured product No. 11a | 6.8 × 10⁻⁴ | Cured product No. 11b | Good |
| Evaluation Example 12 | Cured product No. 12a | 2.2 × 10⁻⁴ | Cured product No. 12b | Good |
| Evaluation Example 13 | Cured product No. 13a | 3.1 × 10⁻⁴ | Cured product No. 13b | Good |
| Evaluation Example 14 | Cured product No. 14a | 5.5 × 10⁻⁴ | Cured product No. 14b | Good |
| Evaluation Example 15 | Cured product No. 15a | 8.2 × 10⁻⁴ | Cured product No. 15b | Good |
| Evaluation Example 16 | Cured product No. 16a | 9.1 × 10⁻⁴ | Cured product No. 16b | Good |
| Comparative Evaluation | Cured product 1a | 4.6 × 10⁻³ | Cured product 1b | Poor |
| Example 1 | | | | |
| Comparative Evaluation | Cured product 2a | 1.2 × 10⁻² | Cured product 2b | Fair |
| Example 2 | | | | |
| Comparative Evaluation | Cured product 3a | O.L.*³ | Cured product 3b | Poor |
| Example 3 | | | | |
| Comparative Evaluation | Cured product 4a | 3.6 × 10⁻³ | Cured product 4b | Fair |
| Example 4 | | | | |

*¹Cured products No. 1a to No. 16a are of Examples, Cured products 1a to 4a are of Comparative Examples.
*²Cured products No. 1b to No. 16b are of Examples, Cured products 1b to 4b are of Comparative Examples.
*³O.L.: Overload (measurement impossible)

As shown in Table 2, it was found that the volume resistance values in Evaluation Examples 1 to 16 are lower than those in Comparative Evaluation Examples 1 to 4, in other words, cured products No. 1a to 16a of Examples are superior to cured products 1a to 4a of Comparative Examples in electric conductivity. Among Evaluation Examples 1 to 16, the volume resistance values in Evaluation Examples 4, 5, 8, and 12 are lower, and the volume resistance values in Evaluation Examples 4, 5, and 8 are particularly lower, and therefore it was found that cured products No. 4a, 5a, 8a, and 12a of Examples are further superior in electric conductivity and that cured products No. 4a, 5a, and 8a of Examples are particularly superior in electric conductivity. In addition, it was found that even when the compositions are cured at a relatively high curing temperature of 200° C., cured products exhibiting an excellent volume resistance value without undergoing thermal decomposition can be obtained. Further, it was found that each of cured products No. 1b to 16b of Examples is a cured product having excellent adhesiveness. As can be seen from those described above, it was demonstrated that a cured product obtained by curing the composition of the present embodiment is a cured product having excellent adhesiveness and heat resistance and having high electric conductivity.

1. A composition comprising
a component (A): at least metal particles selected from the group consisting of copper particles and silver particles,
a component (B): at least one cashew component selected from the group consisting of cashew oils and cashew oil-modified resins, and
a component (C): a curing agent.

2. The composition according to claim 1, wherein the content of the component (B) is 0.1 to 15 parts by mass, and the content of the component (C) is 0.1 to 5 parts by mass, based on 100 parts by mass of the total amount of the composition.

3. The composition according to claim 1, further comprising a component (D): at least one resin selected from the group consisting of xylene resins, phenolic resins, and epoxy resins, excluding the component (B).

4. The composition according to claim 3, wherein the content of the component (D) is 30 parts by mass or less based on 100 parts by mass of the total amount of the composition.

5. The composition according to claim 1, further comprising a component (E): a solvent.

6. The composition according to claim 5, wherein the content of the component (E) is 20 parts by mass or less based on 100 parts by mass of the total amount of the composition.

7. The composition according to claim 1, wherein the component (A) consists of metal particles surface-treated with a fatty acid.

8. A method for producing a cured product, the method comprising:
a coating step of coating a substrate with the composition according to claim 1; and
a curing step of heating the substrate coated with the composition to cure the composition.

9. The method for producing a cured product according to claim 8, wherein the substrate coated with the composition is heated at 50 to 250° C. for 1 to 200 minutes.

10. A cured product obtained by curing the composition according to claim 1.
